(19) United States
(12) Patent Application Publication
(10) Pub. No.: US 2022/0057098 A1
(43) Pub. Date: Feb. 24, 2022

(54) METHOD AND SYSTEM FOR HVAC SYSTEM DATA MAPPING, CONTROL METHOD OF HVAC SYSTEM AND STORAGE MEDIUM

(71) Applicant: CARRIER CORPORATION, PALM BEACH GARDENS, FL (US)

(72) Inventors: Buyun Jing, Shanghai (CN); Zhengang Zhu, Shanghai (CN); Yun Li, Shanghai (CN); Qiang Chen, Shanghai (CN); Yuan Yuan, Shanghai (CN); Danqing Sha, Shanghai (CN); Jinlei Ding, Shanghai (CN)

(21) Appl. No.: 17/252,518

(22) PCT Filed: May 7, 2020
(86) PCT No.: PCT/US2020/031834

§ 371 Date: Dec. 15, 2020

(30) Foreign Application Priority Data
May 9, 2019 (CN) 201910384351.X

(51) Int. Cl. F24F 11/63; F24F 11/52

(52) U.S. Cl. CPC F24F 11/63; F24F 11/52

(57) ABSTRACT

A data mapping method, system and control method for a HVAC system. The data mapping method comprises: providing identification characteristics of at least one target object in the HVAC system, and obtaining information at least related to the target object, according to the identification characteristics, from a building automation system associated with the HVAC system to map a physical topology of the HVAC system comprising at least the target object; providing information of at least one target data point of the HVAC system, and obtaining data point data including at least the target data point from the obtained information or from the building automation system, according to the information of at least one target data point of the HVAC system; and associating the obtained data point data with the physical topology of the HVAC system to obtain physical link mapping data of the HVAC system.

### FIELD OF THE INVENTION

The present invention relates to the technical field of Heating, Ventilation and Air Conditioning (HVAC), and more particularly to a data mapping method for a HVAC system, a data mapping system for a HVAC system, a control method for a HVAC system, and a computer-readable storage medium.

### BACKGROUND OF THE INVENTION

Many types of HVAC systems have been widely used, and they can bring convenience to people's daily work and life. In practical applications, it may be necessary to perform automated operations such as system diagnostics, commissioning and tuning on the HVAC system, which will use mapping data of the HVAC system for information interaction. In addition, when a building automation system (BAS) or a similar system is used to manage the HVAC system, such mapping data is also required to be used. Accordingly, the implementation of data mapping for the HVAC system is important. However, current data mapping operations are labor-intensive and require considerable labor power and material resources, and it is often difficult to guarantee the quality.

### SUMMARY OF THE INVENTION

In view of the above, the present invention provides a data mapping method for a HVAC system, a data mapping system for a HVAC system, a control method for a HVAC system, and a computer-readable storage medium, thereby solving or at least alleviating one or more of the problems described above as well as problems of other aspects existing in the prior art.

Firstly, according to a first aspect of the present invention, a data mapping method for a HVAC system is provided, which comprises the steps of:

providing identification characteristics of at least one target object in the HVAC system, and obtaining information at least related to the target object, according to the identification characteristics, from a building automation system (BAS) associated with the HVAC system to map a physical topology of the HVAC system comprising at least the target object;

providing information of at least one target data point of the HVAC system, and obtaining data point data comprising at least the target data point from the obtained information at least related to the target object or from the building automation system, according to the information of at least one target data point of the HVAC system; and

associating the obtained data point data with the physical topology of the HVAC system to obtain physical link mapping data of the HVAC system.

In the data mapping method for the HVAC system according to the present invention, optionally, the method further comprises the step of: storing the obtained physical topology of the HVAC system, the data point data, and/or the physical link mapping data in a database, and/or outputting the obtained physical topology of the HVAC system, the data point data, and/or the physical link mapping data in the form of a format file.

In the data mapping method for the HVAC system according to the present invention, optionally, the information of the target data point is information of at least one target data point of the target object, the identification characteristics comprise a name of the target object, and the information of the target data point is real-time data information or historical data information, which comprises temperature, pressure, flow rate, speed, humidity, power, and working status.

In the data mapping method for the HVAC system according to the present invention, optionally, data interaction with the building automation system is performed via an application program interface (API).

In addition, according to a second aspect of the present invention, a data mapping system for a HVAC system is also provided, wherein the data mapping system for the HVAC system is in communication with a building automation system (BAS) associated with the HVAC system and is provided with a controller, the controller comprises a processor and a memory for storing instructions, and the processor implements the following operations when the instructions are executed:

according to provided identification characteristics of at least one target object in the HVAC system, obtaining information at least related to the target object from the building automation system to map a physical topology of the HVAC system comprising at least the target object;

according to provided information of at least one target data point of the HVAC system, obtaining data point data comprising at least the target data point from the building automation system; and

associating the obtained data point data with the physical topology of the HVAC system to obtain physical link mapping data of the HVAC system.

In the data mapping system for the HVAC system according to the present invention, optionally, the processor is further configured to: store the obtained physical topology of the HVAC system, the data point data, and/or the physical link mapping data in a database, and/or output the obtained physical topology of the HVAC system, the data point data, and/or the physical link mapping data in the form of a format file.

In the data mapping system for the HVAC system according to the present invention, optionally, the information of the target data point is information of at least one target data point of the target object, the identification characteristics comprise a name of the target object, and the information of the target data point is real-time data information or historical data information, which comprises temperature, pressure, flow rate, speed, humidity, power, and working status.

In the data mapping system for the HVAC system according to the present invention, optionally, data interaction with the building automation system is performed via an application program interface (API).

In addition, according to a third aspect of the present invention, a control method for a HVAC system is also provided, which comprises the step of using the physical topology of the HVAC system, the data point data, and/or the physical link mapping data obtained by the data mapping method for the HVAC system according to any one of the above or by the data mapping system for the HVAC system according to any one of the above.

In addition, according to a fourth aspect of the present invention, a computer-readable storage medium is also provided, which is configured to store instructions that, when executed, implement the data mapping method for the HVAC system according to any one of the above, or implement the control method for the HVAC system as described above.

From the following detailed description combined with the accompanying drawings, the principles, features, characteristics, advantages and the like of the various technical solutions according to the present invention will be clearly understood. For example, as compared with the related art, using the technical solutions of the present invention will have obvious technical advantages. It can not only efficiently and automatically complete the data mapping of the HVAC system, significantly improve the efficiency by more than 10 time and save considerable time, labor power and material cost, but also can effectively guarantee accuracy, provide favorable support for various operations on the HVAC system such as diagnostics, automated commissioning, automated tuning, BAS control, etc., and provide convenience and basis for the application of various intelligent building tools.

### BRIEF DESCRIPTION OF THE DRAWINGS

The technical solutions of the present invention will be further described in detail below with reference to the accompanying drawings and embodiments. However, it is noted that these drawings are designed merely for the purpose of explanation, are only intended to conceptually illustrate the structural configuration described herein, and are not required to be drawn to scale.

FIG. 1 is a schematic flowchart of an embodiment of a data mapping method for a HVAC system according to the present invention.

FIG. 2 is a schematic system block diagram when an embodiment of the data mapping method for the HVAC system shown in FIG. 1 is used.

### DETAILED DESCRIPTION OF THE EMBODIMENT(S) OF THE INVENTION

First, it is noted that the steps, composition, characteristics, advantages and the like of the data mapping method for a HVAC system, the data mapping system for a HVAC system, the control method for a HVAC system, and the computer-readable storage medium according to the present invention will be described below by way of example. However, all the description should not be construed as limiting the present invention in any way.

In addition, for any single technical feature described or implied in the embodiments mentioned herein, or any single technical feature shown or implied in individual drawings, the present invention still allows for any combination or deletion of these technical features (or equivalents thereof) without any technical obstacle, so it should be considered that these more embodiments according to the present invention are within the scope recorded herein. In this context, the technical term “building automation system (BAS)” in a general sense refers to a system that may also be called “building management system” or other similar names in the art, and it may be associated with a HVAC system to perform operations such as control over the HVAC system; the technical term “mapping” refers to an automatically conversion of one object, according to its mutual correspondence between two different sources, from one source to another source.

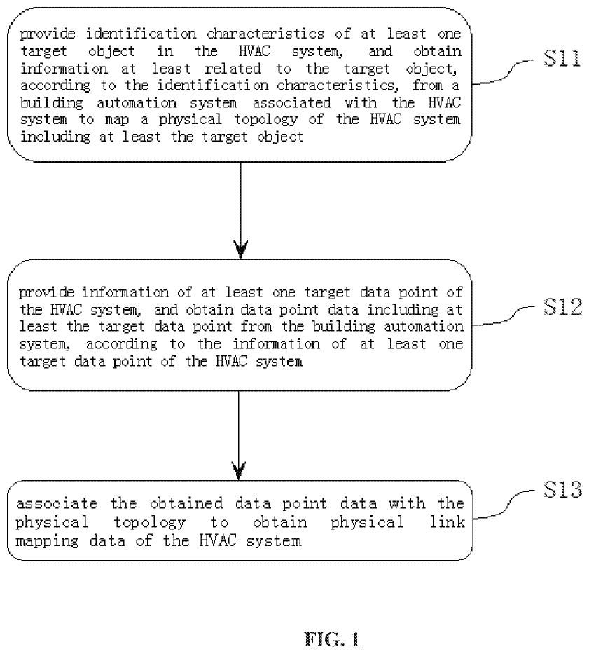

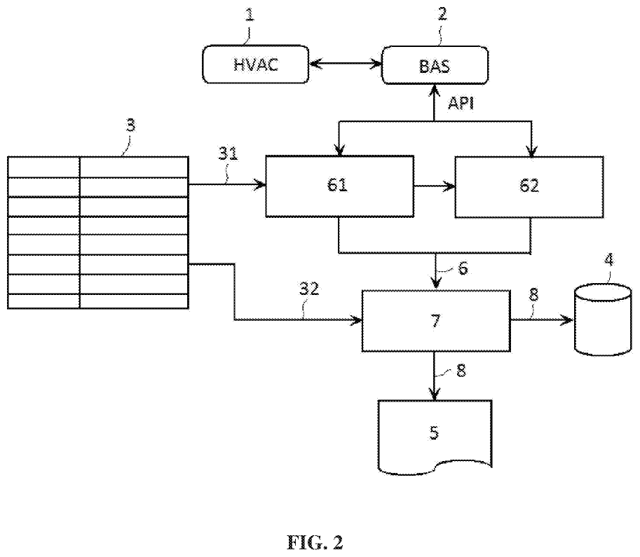

With reference to FIG. 1 and FIG. 2, an embodiment of a data mapping method for a HVAC system according to the present invention is exemplarily shown through the two figures. By way of example, in this given embodiment, the data mapping method may include the following steps:

As shown in FIG. 1 and FIG. 2, in step S11, identification characteristics 31 of one or more target objects in a HVAC system 1 may be provided first, which may be implemented by various information input means such as a human-machine interaction interface 3. The above-mentioned target objects may be any component, unit, module, device or apparatus and the like in the HVAC system, to which the user pays attention according to specific application requirements. They may include, but are not limited to, for example a compressor, an evaporator, a chiller, an air handling unit (AHU), a variable air volume (VAV) box, a valve, a heat exchanger, a first compressor unit, a second compressor unit, etc. In practical applications, the identification characteristics 31 of the target object are allowed to take any possible form; for example, the Chinese name (or abbreviation), English name (or abbreviation), character code of the target object, or a combination of them may be used, as long as it can be identified and confirmed by a building automation system 2 to be described later. By way of example only, the identification characteristics 31 of the target object may optionally be directly defined as the identification or definition adopted for the target object in the building automation system 2 (for example, directly using its abbreviated English name) in order to ensure consistency and improve the efficiency and accuracy of identifying.

In a specific application, an user may input the identification characteristics 31 of the target object in one or more human-machine interfaces as shown in FIG. 2, and then may input them to the building automation system 2 for example through an application program interface (API) so that the building automation system 2 can accordingly detect and obtain information related to this or these target objects in which the user is interested, or also obtain more other information at the same time according to application requirements.

It can be understood that since many types of building automation systems have been provided in the art, for example, tools such as WebCTRL® used for construction, such building automation systems may perform information interaction with the HVAC system 1 and other systems, devices, or apparatuses that may exist through various interfaces or communication methods in order to implement corresponding management controls over them. After the identification characteristics 31 of the target objects in the HVAC system 1 are input into the building automation system 2, the building automation system 2 may obtain information related to this or these target objects in any possible way. For example, the building automation system 2 may obtain relevant information of the target object through device information inside the building automation system 2 (such as information stored in the database of the building automation system 2 itself), or obtain the relevant information from the target object through direct communication with the target object. It should be noted that the actual transmission path of the above information in various places may be wired, wireless or a combination thereof.

Then, a physical topology 6 of the HVAC system 1 can be mapped according to the obtained information of the target object. According to different application requirements, the physical topology 6 may be the complete topology structure of the HVAC system 1, or a part of the topology structure of the HVAC system 1. That is, the physical topology 6 may include only the target object that the user is interested in, may also include other objects in the HVAC system 1 that are associated with the target object, and may even include other objects in the HVAC system 1 that are not associated with the target object. For example, the entire physical topology of the HVAC system 1 can be completely obtained by mapping based on the target object that the user is interested in.

In an actual application, an ID identification of the target object may be performed first, and then a topological relationship identification of the target object in the HVAC system 1 may be performed. This is schematically indicated in FIG. 2 by reference numerals 61 and 62, respectively. Subsequently, the data information obtained through the above processes may be collected and processed so that various target objects and their topological associations in the HVAC system 1 can be obtained, thereby obtaining the above physical topology 6 of the HVAC system 1 by mapping.

In step S12, information 32 of one or more target data points of the HVAC system 1 may be provided so that data point data 7 including at least the above target data point may be obtained based on the above data information that has been collected and processed. Of course, in some applications, the above-mentioned information 32 of one or more target data points may also be input into the building automation system 2 for example through an application program interface or the like, so as to obtain the data point data 7 directly from the building automation system 2. In practical applications, the building automation system 2 may obtain such data point data 7 in any possible way; for example, the data point data 7 may be obtained from the historical data stored in a local or remote database, or it may also be obtained directly through detection components or devices (such as sensors, sensing devices, etc.) that are communicatively connected with the object of the HVAC system 1, or through the object itself (such as its own memory, etc.), or the above two ways may be used at the same time in combination.

According to actual application conditions, different objects in the HVAC system 1 may have the same data point or different data points. The data point information may be, for example, various real-time data information collected by any possible means such as sensors, sensing devices, etc., or various historical data information that has been stored in, for example, various storage components, databases, etc. The information may include, but is not limited to, for example temperature, pressure, flow rate, speed, humidity, power, working status (such as on, off or pause of a device, etc.). They may be identified by, for example, the Chinese name (or the abbreviation), English name (or the abbreviation), character code or a combination of them, etc. In an optional situation, the user may directly input information of the target data point of the target object in which the user is interested in one or more human-machine interfaces shown in FIG. 2, and the information is used as the information 32 of the target data point as described above.

Then, in step S13, both the obtained data point data 7 and the physical topology 6 may be combined, and all the obtained data point data related to a certain object in the HVAC system 1 may be associated with the object to obtain physical link mapping data 8 of the HVAC system 1. It should be noted that in some applications, the physical link mapping data 8 may only include one or more target objects in the HVAC system 1 that the user is interested in and data point data that the user is interested in, that is, these data point data may be only a part of all possibly existing data point data of the above target object. In some other applications, the physical link mapping data 8 may include one or more target objects that the user is interested in and all the data point data thereof. In some other applications, the physical link mapping data 8 may include all the objects in the HVAC system 1 and all the data point data thereof, which will provide complete physical link mapping data of the HVAC system 1.

As described above, in this given embodiment, the physical topology 6, the data point data 7, and the physical link mapping data 8 can be obtained efficiently, quickly, and accurately through these above steps. The obtained data may be flexibly used according to various possible application requirements; for example, the physical topology 6, the data point data 7 and/or the physical link mapping data 8 may be applied to diagnostics, commissioning, tuning and other possible control operations on the HVAC system.

As compared with the art, adopting the solutions of the present invention can improve the data mapping efficiency of the HVAC system by more than 10 times. For example, in the case of high-rise buildings, when faced with thousands of objects and data points, using traditional data mapping processing methods not only takes several hours or more time, but also there may be errors that cannot guarantee a high quality. By contrast, adopting the present method can reduce the time to only a few minutes, and the process can be accurate and error-free, so that the present invention has quite obvious technical advantages. It can provide an application basis for various intelligent building tools and bring great convenience.

It should be noted that in an optional situation, the obtained physical topology 6, data point data 7, and/or physical link mapping data 8 may be directly stored in a database 4 so that they can be provided to different applications for access and utilization. The database 4 may be disposed locally or remotely to meet different application requirements. Additionally, in an optional situation, the obtained physical topology 6, data point data 7, and/or physical link mapping data 8 may be output to the outside in any suitable format file, and a reference numeral 5 is used in FIG. 2 to schematically mark such a format file. It should be noted that the above-mentioned format file may take any possible form of file, such as Excel, XML, DOC, PDF, and the like. In order to facilitate different application requirements, of course, the above two ways may also be used at the same time to process the obtained physical topology 6, data point data 7, and/or physical link mapping data 8.

In addition, the present invention also provides a data mapping system for a HVAC system. It is shown in FIG. 2 that, as an illustrative example, the data mapping system is provided with a controller, the controller may include a processor and a memory for storing instructions, and the processor is configured to implement the following operations when the instructions are executed:

according to provided identification characteristics 31 of at least one target object in the HVAC system 1, obtaining information at least related to the target object from a building automation system 2 associated with the HVAC system 1 so as to map a physical topology 6 of the HVAC system 1 including at least the target object;

according to provided information 32 of at least one target data point of the HVAC system 1, obtaining data point data 7 including at least the target data point from the obtained information related to the target object (or from the building automation system 2); and

associating the obtained data point data 7 with the physical topology 6 to obtain physical link mapping data 8 of the HVAC system 1.

Additionally, as an optional example, the above processor may also be configured to store the obtained physical topology 6, data point data 7, and/or physical link mapping data 8 in a database 4, and/or output the obtained physical topology 6, data point data 7, and/or physical link mapping data 8 to the outside in the form of a format file 5.

It can be understood that, since the data mapping method for the HVAC system according to the present invention has been introduced in the foregoing, and the technical contents such as target object, identification characteristics, target data point, information of target data point, data point data, physical topology, physical link mapping data and the like have already been described in great detail, so references may be directly made to the specific descriptions of the above corresponding parts, and descriptions will not be repeatedly given for the data mapping system for the HVAC system according to the present invention.

Furthermore, according to a technical solution of the present invention, a control method for a HVAC system is also provided, which may include the step of using the physical topology, the data point data, and/or the physical link mapping data obtained by the data mapping method for the HVAC system according to the invention, or the step of using the physical topology, the data point data, and/or the physical link mapping data obtained by the data mapping system for the HVAC system according to the invention. That is, one or more of the above data will be used in the control method for the HVAC system. It should be understood that the above-mentioned control operations for the HVAC system may include, but are not limited to, for example diagnostics, commissioning, tuning, and the like.

In addition, the present invention also provides a computer-readable storage medium for storing instructions that, when executed, can implement the data mapping method for the HVAC system according to the invention, or implement the control method for the HVAC system according to the invention. It should be noted that the above computer-readable storage medium may be any type of component, module, or device used to store instructions, and may include, but is not limited to, a magnetic disk, a hard disk, an optical disk, a U disk, a flash memory, a read-only memory (ROM), a random access memory (RAM), an erasable programmable read-only memory (EPROM), etc.

The data mapping method for a HVAC system, the data mapping system for a HVAC system, the control method for a HVAC system, and the computer-readable storage medium according to the present invention are explained in detail above by way of example only. These examples are only used to explain the principle of the present invention and embodiments thereof, and are not intended to limit the present invention. Those skilled in the art may also make various modifications and improvements without departing from the spirit and scope of the present invention. Therefore, all equivalent technical solutions shall fall within the scope of the present invention and be defined by the claims of the present invention.

1. A data mapping method for a HVAC system, comprising the steps of:
providing identification characteristics of at least one target object in the HVAC system, and obtaining information at least related to the target object, according to the identification characteristics, from a building automation system (BAS) associated with the HVAC system to map a physical topology of the HVAC system comprising at least the target object;
providing information of at least one target data point of the HVAC system, and obtaining data point data comprising at least the target data point from the obtained information at least related to the target object or from the building automation system, according to the information of at least one target data point of the HVAC system; and
associating the obtained data point data with the physical topology of the HVAC system to obtain physical link mapping data of the HVAC system.

2. The data mapping method for the HVAC system according to claim 1, further comprising the step of: storing the obtained physical topology of the HVAC system, the data point data, and/or the physical link mapping data in a database, and/or outputting the obtained physical topology of the HVAC system, the data point data, and/or the physical link mapping data in the form of a format file.

3. The data mapping method for the HVAC system according to claim 1, wherein data interaction with the building automation system is performed via an application program interface (API).

4. The data mapping method for the HVAC system according to claim 1, wherein the information of the target data point is information of at least one target data point of the target object, the identification characteristics comprise a name of the target object, and the information of the target data point is real-time data information or historical data information, which comprises temperature, pressure, flow rate, speed, humidity, power, and working status.

5. A data mapping system for a HVAC system, wherein the data mapping system for the HVAC system is in communication with a building automation system (BAS) associated with the HVAC system and is provided with a controller, the controller comprises a processor and a memory for storing instructions, and the processor implements the following operations when the instructions are executed:
according to provided identification characteristics of at least one target object in the HVAC system, obtaining information at least related to the target object from the building automation system to map a physical topology of the HVAC system comprising at least the target object;
according to provided information of at least one target data point of the HVAC system, obtaining data point data comprising at least the target data point from the building automation system; and
associating the obtained data point data with the physical topology of the HVAC system to obtain physical link mapping data of the HVAC system.

6. The data mapping system for the HVAC system according to claim 5, wherein the processor is further configured to: store the obtained physical topology of the HVAC system, the data point data, and/or the physical link mapping data in a database, and/or output the obtained physical topology of the HVAC system, the data point data, and/or the physical link mapping data in the form of a format file.

7. The data mapping system for the HVAC system according to claim 5, wherein data interaction with the building automation system is performed via an application program interface (API).

8. The data mapping system for the HVAC system according to claim 5, wherein the information of the target data point is information of at least one target data point of the target object, the identification characteristics comprise a name of the target object, and the information of the target data point is real-time data information or historical data information, which comprises temperature, pressure, flow rate, speed, humidity, power, and working status.

9. A control method for a HVAC system, which comprises the step of using the physical topology of the HVAC system, the data point data, and/or the physical link mapping data obtained by the data mapping method for the HVAC system according to claim 1.

10. A computer-readable storage medium, which is configured to store instructions that, when executed, implement the data mapping method for the HVAC system according to claim 1.
